(19) United States
(12) Patent Application Publication
(10) Pub. No.: US 2008/0254798 A1
(43) Pub. Date: Oct. 16, 2008

(54) Handover Method and System

(75) Inventors: John Power, Kilmacthomas (IE); James O'Meara, Athlone (IE); Raymond Murphy, Stockholm (SE); Edwin Tse, Montreal (CA); Robert Petersen, Linkoping (SE)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/850,907

(22) Filed: Sep. 6, 2007

Related U.S. Application Data
(63) Continuation of application No. 60/910,896, filed on Apr. 10, 2007.

(51) Int. Cl. H04Q 7/20

(52) U.S. Cl. 455/436

(57) ABSTRACT

Systems and methods are described which provide cell data between radio network controllers including monitoring at least one cell being controlled by a first radio network controller, compiling cell data based on configuration changes to the at least one cell and transferring the compiled cell data to at least a second radio network controller connected to the first controller over an inter controller link.

### PRIORITY APPLICATION

This application claims priority from Provisional U.S. Patent Application No. 60/910,896 filed on Apr. 10, 2007 and entitled “Method and System for Optimizing the Call Connection Handover Process in Cellular Communication Network”, the subject matter of which incorporated herein by reference.

### TECHNICAL FIELD

The present invention relates generally to cellular telecommunication networks and in particular to methods and systems for optimizing a call handover process.

### BACKGROUND

In a cellular mobile telecommunications system, the user of a mobile station or user equipment (UE) communicates with the system through a radio interface while moving about the geographic coverage area of the system. The radio interface between the mobile station and system is implemented by providing base stations (BS) dispersed throughout the coverage area of the system, each capable of radio communication over a wireless interface with the mobile stations operating within the system. In a typical mobile telecommunications system, each base station of the system controls communications within a certain geographic coverage area ideally represented by a hexagonal shape termed a cell, and a mobile station which is located within a particular cell communicates with the base station controlling that cell. The UE within a cell may be controlled by one or more of the following: radio network controllers such as a base station controller (BSC) of the GSM system or a radio network controller (RNC) of the third generation systems and core network controllers such as a mobile switching center (MSC) of the GSM system and a serving GPRS support node (SGSN).

When a call is initiated by a UE, or received at the system for a UE, the call is set up on radio channels assigned to the base station controlling the cell in which the UE is located. The UEs have a limited range with respect to the BS. A handover occurs when the UE moves out of range of its existing BS within a given cell, i.e., the radiofrequency (RF) characteristics of the call connection deteriorate below a specified level or the RF characteristics of another BS in a neighboring cell increases beyond a specific threshold. Instead of allowing the call connection signal to deteriorate to noise level, the call connection is transferred or handed-over to the controller of the BS of the neighboring cell to maintain the call. As the user (of the UE) continues to move throughout the system, control of the call may be transferred from the neighboring cell to another cell. Handovers may also be necessary in other situations (i.e. other than seeking best RF characteristics for the call) to handle call congestion, for example.

Handoff can only be effective if the call is transferred to radio channels that provide adequate signal strength for two way communications. This requires sufficient signal strength at both the receiver of the mobile station and receiver of the base station to which handoff is made. The signals must also be sufficiently strong in relation to any noise or interference that is present in the network.

With reference to FIG. 1, a portion of a radio access network is illustrated designated by the reference numeral 100. A UE 110 operates within network 100. Only one UE 110 is illustrated for simplicity. It should, however, be understood that hundreds of discrete UEs would normally be operational within each cell of network 100. The UE 110 is in contact with a BS 115 while roaming within cell 120. Cells 125, 130, 135, 140, 145 and 150 neighbor the active cell 120. With further reference to FIG. 1, the UE 110, currently operating within active cell 120, is moving toward neighboring cell 125 (as indicated by the arrow), the communications within which are controlled by another BS 155. It should be understood that BSs 115 and 155 preferably cover three-sector cells by use of antennas with pointing azimuths of 120 degrees. In other words, BS 115 covers each of cells 120, 140 and 145.

When UE 110 moves out of the range of BS 115, i.e., outside of cell 120, or more within the range of neighboring BS 155, i.e., within cell 125, a handover is initiated from BS 115 to BS 155, which then handles all of the wireless communications for that UE 110 while within communications contact. It should be understood, however, that another handover may shift control back to BS 115 should the MS 110 remain at the signal border between the base stations or geographical or meteorological characteristics come into play.

Inter-cell handovers are relatively straightforward when between cells under common control of a Radio Network Controller (RNC), which coordinates coverage over a group of cells (Each RNC may control multiple cells and multiple BSs). A base station BS in Utran is called NodeB. A RNC can control multiple NodeBs; each NodeB has multiple Cells. Communications across discrete RNC coverage areas or between different Public Land Mobile Networks (PLMN), however, are more complicated, and much more identification information is required to effectuate cell-to-cell handovers across such boundaries. In addition to cell identities, RNC and other controller information is required to effectively make such call transfers. For example, in an inter-RNC transfer, the signaling network address of the new RNC, along with relevant cell and neighboring cell data, is stored within the originating RNC to effectuate such handovers in conventional systems. The reason for the permanent storage of such elaborate routing information is to be prepared for all possible handovers.

The above described mechanism, however, is not dynamic. Information within the RNCs (such as the operational and administrative state of the cells, the addition or removal of the cells or any configuration changes to the cells) may not be current (or up to date); rather, the information is updated periodically (such as once a day or several times a day). Exemplary embodiments described below address the need for maintaining a near real-time information about (the operational state and current configuration of) target cells within the source RNC. A source RNC is the RNC that controls the cell that a UE is about to leave and the destination RNC is the RNC that controls the cell where the UE is about enter.

### SUMMARY

According to one exemplary embodiment of the invention, a method for providing cell configuration data includes monitoring at least one cell being controlled by a first radio network controller, compiling cell data based on configuration changes to the at least one cell and transferring the compiled cell data to at least a second radio network controller connected to the first controller over an inter controller link.

According to another exemplary embodiment of the invention, a method for handing over user equipment includes receiving cell data from a first radio network controller by a second radio network controller connected to the first radio network controller wherein the cell data is associated with cells corresponding to the first radio network controller and the user equipment operates within cells corresponding to the second radio network controller, updating a cell record by the second radio network controller, identifying potential handover cells corresponding to the first radio network controller and providing the identity of the potential handover cells to the user equipment wherein the cell data is transferred over an inter controller link.

According to yet another exemplary embodiment of the invention, a radio system includes a plurality of radio network controllers wherein a first of the radio network controllers monitors at least one cell corresponding to the first radio network controller, compiles cell data for the at least one cell and transfers the compiled cell data to at least a second of the radio network controllers, wherein the second radio network controller is connected to the first radio network controller and the cell data is transferred over an inter controller link.

According to other exemplary embodiments of the invention, the radio network controller includes a processor in communications with a memory unit. The processor monitors the at least one cell, compiles the cell data and transfers the compiled cell data.

### BRIEF DESCRIPTION OF THE DRAWINGS

The accompanying drawings illustrate exemplary embodiments, wherein:

FIG. 1 depicts a portion of a radio network illustrating movement of a user equipment (UE) between cells;

FIG. 2A depicts a portion of a radio network architecture with one control element controlling multiple cells;

FIG. 2B depicts a portion of a radio network architecture with multiple controllers each controlling a cell;

FIG. 2C depicts portions of multiple radio networks with multiple controllers each controlling a cell;

FIG. 3 depicts the combination of the radio networks of FIGS. 2A to 2B;

FIG. 4 depicts an exemplary method of transferring cell data among radio controllers over multiple radio networks;

FIG. 5 depicts an exemplary method for processing cell data received by a controller; and

FIG. 6 depicts a network controller according to exemplary embodiments.

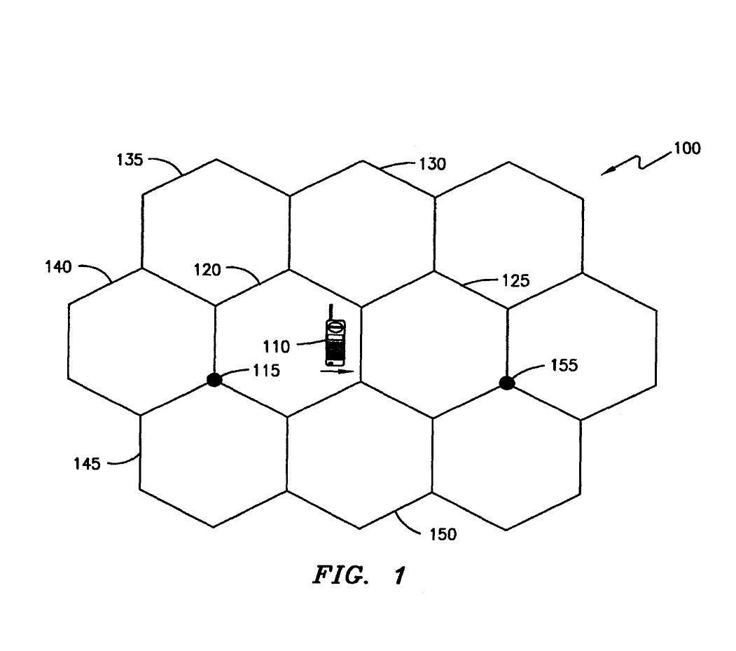

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

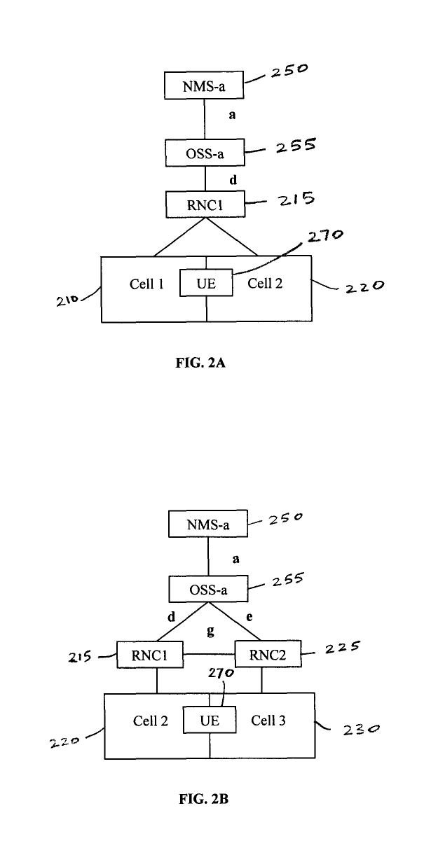

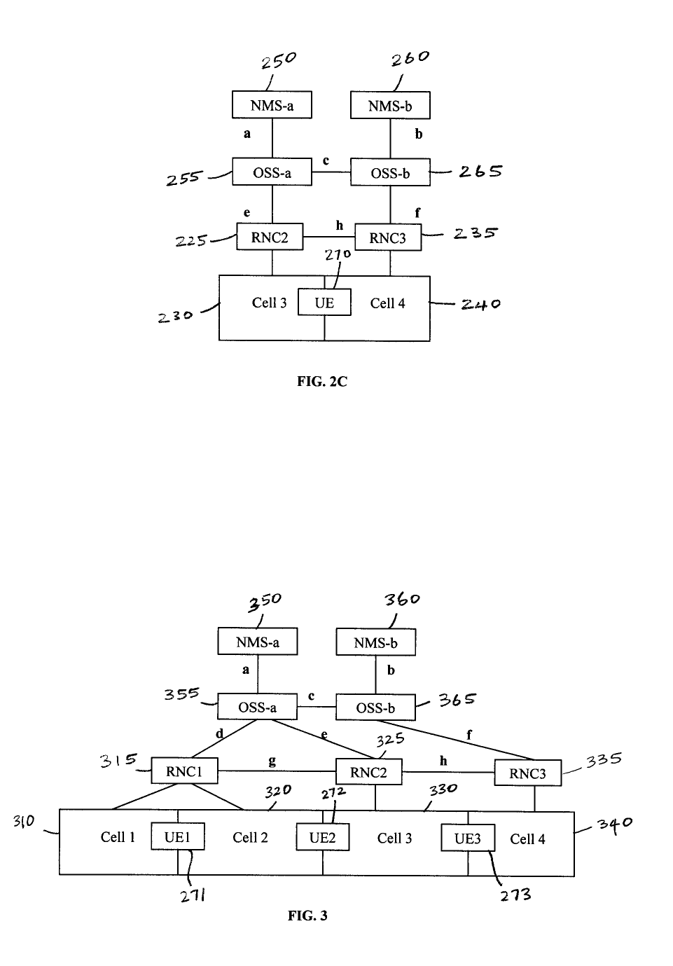

As described above, the handover mechanism takes place between cells. The source controller (i.e. the controller that controls the BS interfacing with the UE) decides the timing and the target cell for the handover. That decision requires knowledge of the configuration data (called cell data) of the two cells involved in the transfer (i.e. the source cell and the target cell). Handover may be encountered in one of the following exemplary scenarios: (1) The source and target cells may be controlled by the same controller (RNC) as illustrated in FIG. 2A; (2) The source and target cells may be controlled by different controllers as illustrated in FIG. 2B; and (3) The source and target cells may be in different PLMNs (and controllers) as illustrated in FIG. 2C. Exemplary methods as described herein may be implemented regardless of whether the two controllers are in the same or in different PLMNs as long as an inter controller link (such as an Tur link in 3GPP) is established between the PLMNs.

For purposes of ease of illustration, cells are designated by rectangles (in FIGS. 2A-2C and 3) as opposed to hexagons. UEs moving between cells are illustrated as rectangles placed at the intersection of two rectangles which represent cells.

The first scenario is illustrated in FIG. 2A. As a UE 270 moves from cell1 (210) toward cell2 (220), handover of UE 270 may take place from cell 210 to cell 220. Since RNC 1 (215) may be controlling both cell 210 and cell 220, the handover from cell 210 to cell 220 is straightforward since RNC 215 contains information about both of cell 210 (source cell) and cell 220 (target cell). Operating support system 255 and network management system 250 are also illustrated in FIG. 2A. These are both well known and are not relevant for understanding and/or implementing exemplary embodiments of the invention as described herein.

The second scenario is illustrated in FIG. 2B. As UE 270 moves from cell2 (220) toward cell3 (230), handover of UE 270 may take place from cell 220 to cell 230. Unlike the scenario described above, however, RNC1 (215) only controls cell 220 (the source cell) and not cell 230 (the target cell). RNC 215 does not contain all of the current information about cell 230. In this situation, cell 230 is controlled by RNC2 (225). RNC 215 may obtain information about cell 230 from OSS-a (255) since OSS-a of controllers RNC 215 and RNC 225 contains information (i.e. cell data) for both of cells 220 and 230. OSS-a 255 obtains the cell data from NMS-a 250 via a predefined protocol (over connection “a”) and from the RNCs. RNC 215 may then obtain the information on cell 230 from OSS-a 255 via interface “d”.

The third scenario is illustrated in FIG. 2C. As UE 270 moves from cell3 (230) toward cell4 (240), handover of UE 270 may take place from source cell 230 to target cell 240. In this scenario, RNC2 (225 corresponding to source cell 230) does not contain all of the current information about target cell 240. Furthermore, unlike the second scenario highlighted above, OSS-a 255 of source controller RNC 225 also does not contain information about the target cell 240. In this scenario, OSS-a 255 may obtain cell data of target cell 240 in one of two ways: (1) OSS-a 255 may obtain cell data for cell 240 from NMS-a 250 via “a” as illustrated; or (2) OSS-a 255 may obtain cell data for cell 240 from OSS-b 265 via “c”.

It is not always practical and/or efficient to rely on communication between two OSSs to pass the information about changing radio configurations. An alternative is provided for according to exemplary embodiments. In both the second and third scenarios described above, the type of cell data obtained by OSS-a from the target cells (target cell 230 in the second scenario and target cell 240 in the third scenario) is static. The cell data obtained/transferred includes radio frequencies and scrambling codes for example. The cell data does not include data related to administrative and operational states of the target cells. Examples of such type of cell information may include a state of cell congestion or a cell being temporarily down. Since this type of information is not available, the UE is instructed by the source controller (RNC 215 in the second scenario and RNC 225 in the third scenario) to monitor the potential target cells even if the target cells are unavailable for handover. A downside to this process is the energy wasted in the UE in performing this monitoring. Battery time is reduced and length of time to find a target is increased. Coverage in the source cell may be lost before a target cell is found (i.e. loss of call or reduction in the voice quality).

In the second scenario, target cell data (of cell 230) is forwarded by RNC 225 to OSS-a 255 via “e” and then to source cell 220 (from OSS-a 255) via “d”. This two-step transfer introduces delay in the transmission of the data about the target cell 230 to source cell 220.

In the third scenario, target cell data (of cell 240) is forwarded by RNC 235 to OSS-b 265 via “f”, then to OSS-a 255 via “c” (from OSS-b 265) and then to source cell 230 (from OSS-a 255) via “e”. This three-step transfer also introduces delay in the transmission of the data about the target cell 240 to source cell 230 as these interfaces are typically “management initiated”; that is, they are scheduled on an hourly or daily or weekly basis. The delay depends on the computing and transmission resources and the volume and nature of changed data.

Exemplary embodiments reduce delays in transmission of target cell data utilizing existing protocols for transferring data between controllers (and not having to involve the OSSs such as OSS-a 255 and OSS-b 265).

A network combining elements of FIGS. 2A-2C is illustrated in FIG. 3. The Radio Network Subsystem Application Part (RNSAP) protocol may be utilized to transfer information (data) about cells between the controllers of FIG. 3. Currently, calls and call control data are passed between controllers using RNSAP protocol. Control data is for signaling control or to “traffic domain functions” and not for network management control. Example of data may include “UE measurement reporting”, “Paging”, “Radio Link Setup”, etc. The physical link between controllers in 3GPP is the Iur. The protocol is defined at http://www.3gpp.org/ftp/Specs/html-info/25423.htm. A new protocol data element within RNSAP may be introduced to transfer the data in an exemplary embodiment. The transferred data may include cell information. Cell information may include static information such as radio frequencies and scrambling codes for example as well as cell administrative and operational state information that may be transferred between RNC 335 and RNC 325 and between RNC 325 and RNC 215. The data may be transferred over the known Tur link between the controllers. Alternatively, the 3GPP standard may specify a new protocol between the RNCs called “OAMSAP” or “RANCELLSAP” or the like.

The new protocol data element may be sent from a controller when a configuration change has been made to a corresponding cell (i.e. to a cell being controlled by the particular controller). Referring to FIG. 3 for example, if configuration changes are made to cell 340, then RNC 335 may send or broadcast the cell configuration changes made to cell 340 using the new protocol data element via all Tur links connected to RNC 335. In this example, RNC 335 may broadcast this data to RNC 325 via Tur link “h”. Similarly, if configuration changes take place for cell 330, then RNC 325 may broadcast this information via Tur link “h” to RNC 335 and via Tur link “g” to RNC 315. Any configuration changes to cells 310 or 320 may be broadcast by RNC 315 via Tur link “g” to RNC 325. Data may be sent to all controllers having a link with the broadcasting controller (e.g. RNC 315 and RNC 335 receiving data from RNC 325 when changes take place to cell 330 in FIG. 3).

The data broadcast may contain operation and management information and not signaling information. This data may be broadcast while the Tur link is idling resulting in the new protocol data element not having to compete for resources (such as CPU and memory) with UE call traffic. The configuration information or data may be sent via the Tur link whenever the Tur link is re-established following such events as link restoration, node restart and major reconfiguration changes such as upgrades or base station re-homing for example. Each of these exemplary events are known and are not described further.

A controller receiving the data via the Tur link may update its cell data which can be used in subsequent handover selection, configuration and performance measurements for example.

Each controller connected to a broadcasting controller may thus receive cell data from the broadcasting controller (such as RNC 315 and RNC 335 receiving data from RNC 325 since RNC 315 and RNC are both connected to broadcasting controller RNC 325 in this illustrative example). The receiving controller may utilize the received data for many purposes in various exemplary embodiments as described below:

The receiving controller may discard data for particular cells for a number of reasons. A particular cell may be set up but may not yet be in service—that is, it is being commissioned and tested but not being used for service. A particular cell may not be in a receiving cell's “priority” list—that is, the receiving cell may have ten candidate handover cells in the “priority” list and the particular cell for which data is received may not be one of these ten cells in the “priority” list. Therefore, the receiving cell may not handover to this particular cell under normal operating conditions. The receiving cell may be undergoing maintenance such as upgrade and the configuration of the receiving cell may be “frozen” until configuration is complete. The receiving controller may, on the other hand, also store data on cells with which the receiving controller may not have an existing handover relationship. These cells may be identified as potential handover targets.

A controller (such as RNC 325 of FIG. 3 for example) may establish a subscription mechanism with other controllers connected to it (such as RNC 315 and RNC 335). RNC 325 may inform RNC 315 and RNC 335 about modifications to a cell (cell 330 in this illustrated example) or if a new cell has been added (and which also corresponds to RNC 325). The connected controllers (RNC 315 and RNC 335) may respond to RNC 325 and indicate whether it wished to continue to receive data about the modified or newly added cell, or wish to be removed from further notifications about these cells.

The receiving controller may store or update cell data of cells to which the controller has an existing handover relation, and utilize this information when informing the UE as to which potential target cells to measure/monitor.

The receiving controller may maintain a list of cells for which the controller has not received measurements (from a UE) for a defined period of time since such cells are not likely to be a handover target. Cell data received for these cells may be discarded without processing. These cells may also be removed from the list of potential future handover targets.

Cell data may be broadcast by a controller utilizing two RNSAP type protocol data elements. The elements are “Neighbor Cell Modification” and “Neighbor Cell State Modification”. These elements are two “proposed” new additional messages in the RNSAP protocol and are based loosely on “Neighbouring UMTS Cell Information” message for example.

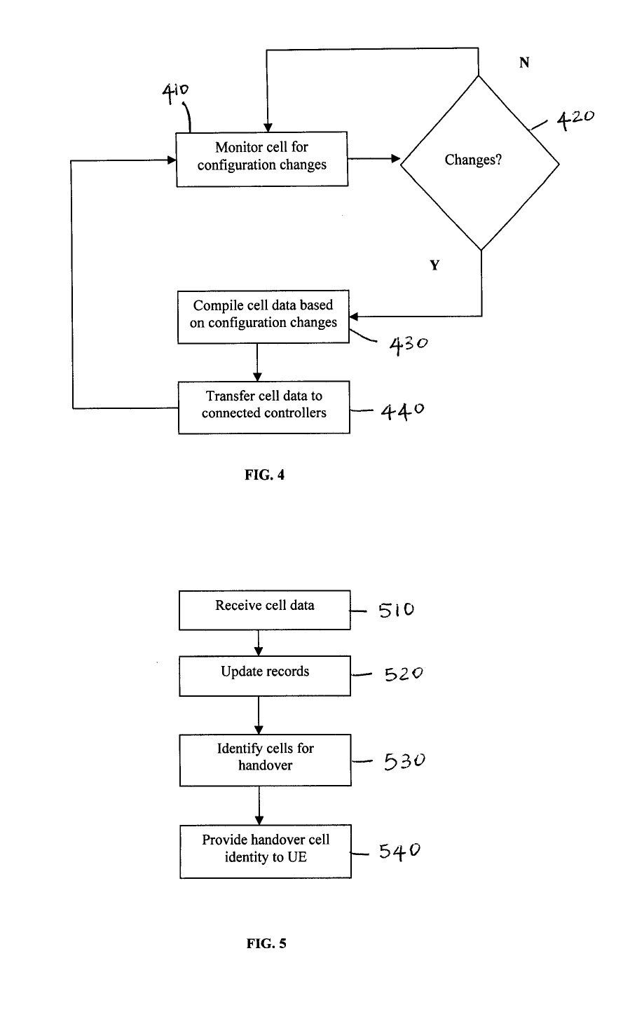

A method in accordance with exemplary embodiments may be described with reference to FIG. 4. A controller RNC 335 of FIG. 3 may monitor for configuration changes in the corresponding cells (i.e. cells that the RNC controls) such as in cell 340 in this example (at step 410). If configuration changes occur as determined (at step 420), cell data for cell 340 may be compiled (at step 430). The cell data may then be transferred to other controllers such as RNC 325 that is connected to the transferring cell RNC 335 (at step 440). If the monitoring is being performed by controller RNC 325 and cell configuration changes occurred, then RNC 325 may transfer cell data to both RNC 315 and RNC 335 since both of these controllers are connected to RNC 325. The transferring controller may be referred to as a first radio network controller and receiving controllers may be referred to as second radio network controllers. As described above, the transfer may take place over a Iur link (in 3GPP) between the first and second controllers utilizing the RNSAP protocol. The transfer, however, need not take place over Iur link for implementing exemplary embodiments of this invention. In general, exemplary embodiments may be implemented in any setting where an inter network link has been established between two network controllers.

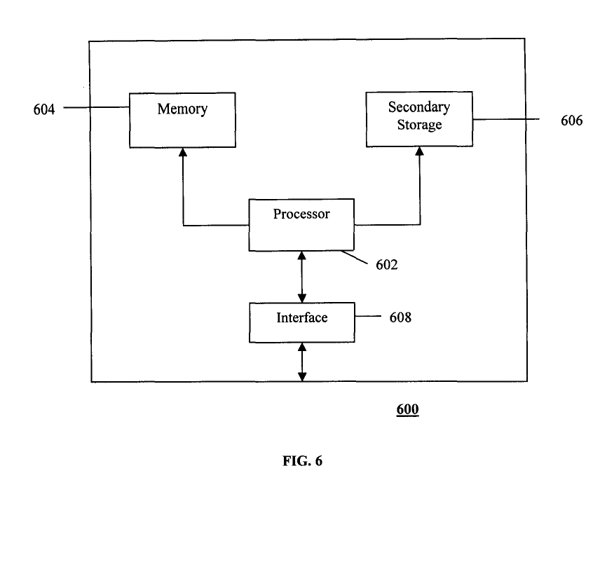

A method in accordance with exemplary embodiments may be described with reference to FIG. 5. A controller such as RNC 325 of FIG. 3 may receive cell data (of cell 340 for example) from RNC 335 (at step 510). RNC 325 may update its records with configuration changes of cell 340 (at step 520). The records of RNC 325 may include information (both static and dynamic) on cells that may be potential handover cells. RNC 325 may then identify potential cells for handover (at step 530) based on the received cell data. RNC 325 may then provide the cell identity of potential handover cell to UEs operating within cells being controlled by RNC 325 (at step 540) which in this case may be UE 273. UE 273 may then measure the identified cells.

Exemplary embodiments as described herein eliminate transfer of cell data between radio controllers at the OSS level in the radio network architecture. Instead, the data is exchanged at the controller level which results in a near real-time synchronization/updating of changes in the network. Furthermore, the data may be selectively disseminated/transferred between controllers.

The exemplary embodiments described above provide for communication of cell data involving radio network controllers, user equipment and other network elements. An exemplary radio network controller 600 will now be described with respect to FIG. 6. Radio network controller 600 can contain a processor 602 (or multiple processor cores), memory 604, one or more secondary storage devices 606 and an interface unit 608 to facilitate communications between radio network controller 600 and the rest of the network. The memory can be used for storage of exemplary items described above such as the cell data, identity of the user equipment operating within cells corresponding to the radio network controller or any other relevant information. Thus, a radio network controller according to exemplary embodiments may include a processor for transmitting and receiving messages associated with cell data related to a mobile network.

Exemplary embodiments as described provide for configuration of networks which includes management, operation and/or maintenance of networks. The management of the networks provides the traffic domain (i.e. data needed by a UE during handover) with the information needed to select and initiate a handover. The traffic domain ensures that the candidates are valid and in the event of failure, select another candidate.

Cell data may be communicated when a notifiable change occurs; that is, when relevant data changes. Cell data may also be communicated at link establishment (i.e. when a link between nodes is added) or re-establishment (i.e. when a link is setup after a transmission disturbance for example). Cell data may be communicated at a (scheduled) pre-determined frequency such as at a particular time every day. Cell data may be communicated upon operator initiation—the network operator may request a manual synch between a given set of nodes such as upon addition of new nodes, software upgrade, network frequency replan, etc.

The above-described exemplary embodiments are intended to be illustrative in all respects, rather than restrictive, of the present invention. While the link between controllers is referred to and described as a Tur link, exemplary embodiments as described herein may be equally applicable in any type of network having any type of an inter controller link. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for providing cell configuration data, the method comprising:
monitoring at least one cell being controlled by a first radio network controller;
compiling cell data based on configuration changes to the at least one cell; and
transferring the compiled cell data to at least a second radio network controller connected to the first controller wherein the cell data is transferred over an inter controller link.

2. The method of claim 1 wherein the transferred data includes information on operational state of the cell.

3. The method of claim 2 wherein the operational state includes information on cell congestion.

4. The method of claim 2 wherein the operational state includes information on a cell being down.

5. The method of claim 1 wherein the transferred data includes information on radio frequencies.

6. The method of claim 1 wherein the transferred data includes information on scrambling codes.

7. The method of claim 1 wherein the data is transferred utilizing a RNSAP protocol.

8. The method of claim 1, wherein the inter controller link is an Iur link.

9. The method of claim 1 wherein the data is communicated at a predetermined interval.

10. The method of claim 1 wherein the data is communicated upon operator initiation.

11. The method of claim 1 wherein the data is communicated at link establishment.

12. A method for handing over user equipment, the method comprising:
receiving cell data from a first radio network controller by a second radio network controller connected to the first radio network controller, wherein the cell data is associated with cells corresponding to the first radio network controller and the user equipment operates within cells corresponding to the second radio network controller;
updating a cell record by the second radio network controller;
identifying potential handover cells corresponding to the first radio network controller; and
providing the identity of the potential handover cells to the user equipment wherein the cell data is transferred over an inter controller link.

13. The method of claim 12 wherein the cell data includes cell configuration data.

14. The method of claim 12 wherein the cell data includes operational state of the cells.

15. The method of claim 12 wherein the data is transferred utilizing a RNSAP protocol.

16. The method of claim 12 wherein the inter controller link is an Iur link.

17. A radio system comprising:
a plurality of radio network controllers wherein a first of the radio network controllers:
monitors at least one cell corresponding to the first radio network controller;
compiles cell data for the at least one cell; and
transfers the compiled cell data to at least a second of the radio network controllers, wherein the second radio network controller is connected to the first radio network controller and the cell data is transferred over an inter controller link.

18. The radio system of claim 17 wherein the cell data includes cell configuration data.

19. The radio system of claim 17 wherein the cell data includes operational state of the cells.

20. The radio system of claim 17 wherein the data is transferred utilizing a RNSAP protocol.

21. The radio system of claim 17 wherein the inter controller link is an Iur link.

22. The radio system of claim 17 wherein the radio network controller comprises:
a processor in communications with a memory unit wherein the processor monitors the at least one cell, compiles the cell data and transfers the compiled cell data.
